(19) United States
(12) Patent Application Publication
(10) Pub. No.: US 2003/0090208 A1
(43) Pub. Date: May 15, 2003

(54) Collector

(76) Inventors: Robert Wilson, Maldon (GB); Steven Bardell, Great Dunmow (GB); Timothy A Crompton, Tiptree (GB)

Correspondence Address: Kirschstein Ottinger, Israel & SchiffMiller, 489 Fifth Avenue, New York, NY, 10017-6105, US

(21) Appl. No.: 10/203,118

(22) PCT Filed: Feb. 5, 2001
(86) PCT No.: PCT/GB01/00452

(30) Foreign Application Priority Data
Feb. 4, 2000 (GB) 0002523.9

(51) Int. Cl. H01J 23/02

(52) U.S. Cl. 315/5.38

(57) ABSTRACT

In a multistage collector used in a linear beam tube such as an IOT or klystron, electrode stages (1, 2 and 3) are separated by ceramic rings (5 and 6) having metallised surfaces (7 and 9) to provide distributed bypass capacitors. This eliminates or reduces leakage or any rf energy from the interior of the collector to the outside.

This invention relates to collectors for electron beam tubes.

Linear electron beam tubes are used for the amplification of rf signals. They incorporate an electron gun for the generation of an electron beam of the appropriate power. The electron gun has a cathode heated to a high temperature so that the application of an electric field results in the emission of electrons, the electric field being produced by spacing an anode in front of and some distance from the cathode. Typically, the anode is held at ground potential and the cathode at a large, say several tens of kilovolts, negative potential.

In one type of linear beam tube called an Inductive Output Tube (IOT), a grid is placed close to and in front of the cathode and an rf signal to be amplified is applied between the cathode and grid so that the electron beam generated in the gun region is density modulated. The density modulated electron beam is directed through an rf interaction region which includes one or more resonant cavities. The beam may be focussed by magnetic means, to ensure that it passes through the rf region, and delivers power at an output section where the amplified rf signal is extracted.

After passing through the output section the beam enters a collector where it is collected and the remaining power on it is dissipated. The amount of power needing to be dissipated depends upon the efficiency of the linear beam tube, this being the difference between the power of the beam generated at the electron gun region and the rf power extracted in the output coupling of the rf region.

A collector may consist of a single component, usually of copper, which operates at ground potential or close to ground potential. It is known to improve the overall efficiency of an amplifier tube by using a collector consisting of a number of electrically isolated stages each operating at a potential at or between ground and cathode potential. In one such typical arrangement for a high power klystron used for the amplification of television signals at uhf frequencies the collector has 5 stages, the difference in potential between the various stages being 25% of the beam voltage. By using such a multi-stage collector, the electrons in the beam are slowed down before impacting on the electrode surfaces thus leading to greater recovery of energy. Collectors may of course have a different number of stages operating at different potentials to effect an energy saving.

According to a first aspect of the invention, a multi-stage collector for an electron beam tube comprises: at least two electrode stages with a dielectric ring located between them) the ring having a metal plate on each of its end faces electrically connected to respective different stages such that they act together with the ring to define a high frequency distributed bypass capacitor.

The ring is an annulus, the radial distance between its outer and inner peripheries being equal to or greater than the axial distance between its end faces. This is in contrast to a conventional arrangement in which electrical insulation between adjacent electrode stages is provided by a dielectric cylinder having a significant axial length compared to the thickness of its wall. By using the invention, the ring enables a high capacitance to be achieved as the distance between the plates is small compared to their surface area. Thus the combination of the ring and the metal plates is able to perform as a bypass capacitor which is effective as a low impedance at high frequencies. The electron beam entering the collector is modulated by rf current components, generating rf voltages in the collector region. This can result in rf leakage occurring from the inside of the collector to the outside of the collector through insulators separating collector stages. Use of the invention permits rf leakage through the insulators to be reduced or eliminated compared to a conventional construction. Preferably the ring is of a ceramic material, but other forms of insulator may be suitable.

In a preferred embodiment, at least one of the metal plates consists of a metallisation layer, which may be laid down accurately using well known techniques. However, the metal plates could instead comprise separately fabricated components which are then fixed to the surface of the ring.

Advantageously, at least one of the metal plates does not extend to the inner and outer peripheries of the face on which it is located. Thus, in addition to the axial thickness of the ring providing a certain path length between components at different electrical potentials, there is also the distance between the edge of the metal plate and the periphery. It is therefore possible to obtain the same voltage hold-off with the dielectric ring as would be possible with a dielectric cylinder of greater axial length. This also provides a more compact collector in the axial direction.

The invention may be applied to a collector formed as a single piece, with the dielectric ring being located between the collector and the body of the tube to which it is fixed. The distributed bypass capacitor is thus defined by the collector body, ring and tube body. Thus, a further aspect of the invention provides an electron beam tube comprising two stages, one of which is a collector, with a dielectric ring between them the ring having a metal plate on each of its end faces electrically connected to the respective stages such that, together with the ring, they define a high-frequency bypass capacitor. This arrangement may be advantageous where the collector is operated at depressed voltage to give improved energy efficiency.

One way in which the invention may be performed is now described by way of example in which:

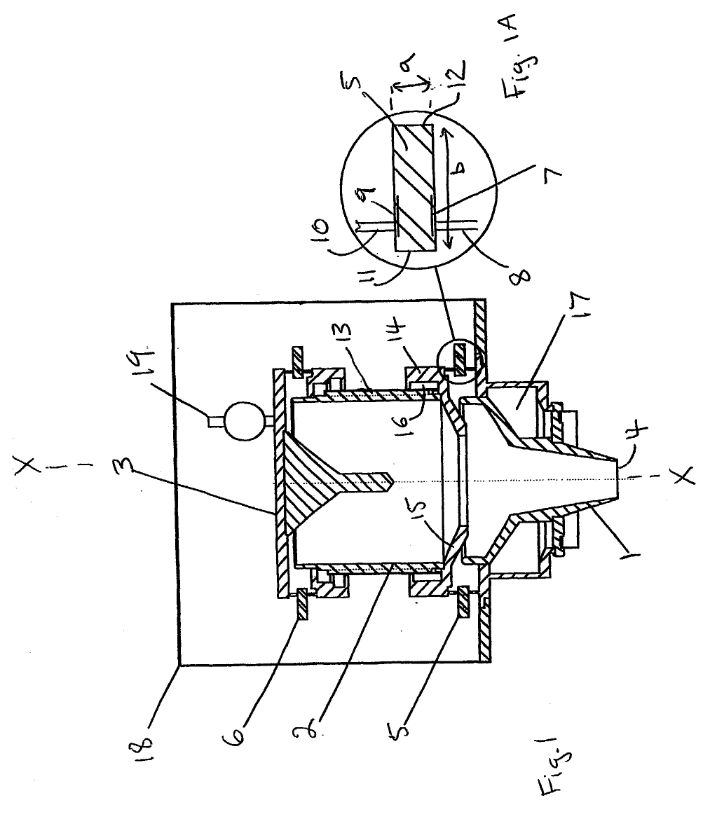

FIG. 1 schematically shows a multi-stage collector in accordance with a first aspect of the invention;

FIG. 1A is an enlarged part of FIG. 1; and

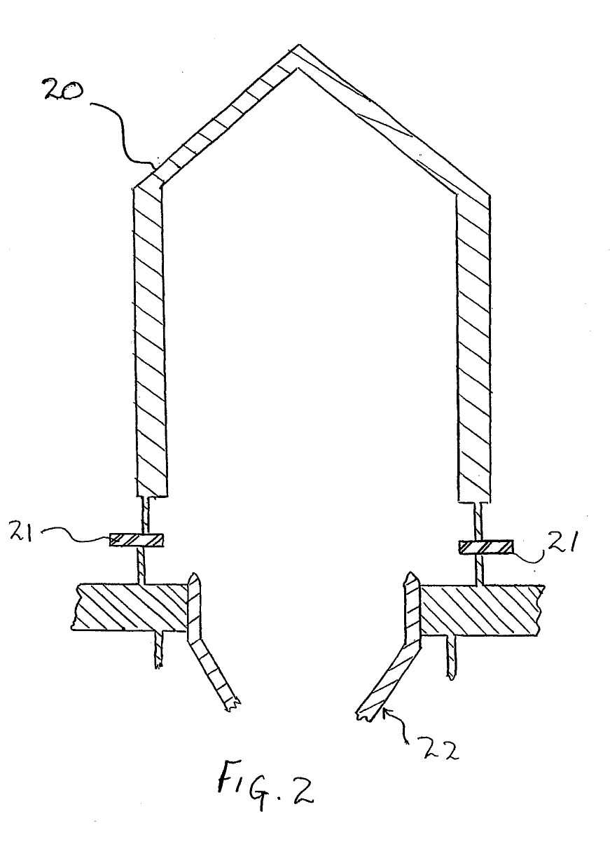

FIG. 2 schematically shows a portion of an electron beam tube constructed in accordance with a second aspect of the invention.

With reference to FIGS. 1 and 1A, a multi-stage electron beam collector includes a first electrode stage 1, second electrode stage 2 and a third electrode stage 3 arranged along a longitudinal axis X-X along which, during use, an electron beam enters the collector at opening 4 of the first stage 1, which also acts as the output drift tube.

A ceramic annular ring 5 is located between the first stage 1 and second stage 2 and another annular ceramic ring 6 between stages 2 and 3. The ring 5 includes a region of metallisation 7 on an end face. The metallisation is in electrical contact with a thin cylindrical metal wall 8 which is as at the same potential as the first stage 1 and thus effectively forms part of the first collector stage. Similarly, on the opposing end face of the ring 5 another layer of metallisation 9 is in electrical contact with a thin cylindrical wall 10 which forms part of the second stage 2. The ring 6 between the second and third stages 2 and 3 also has metallisation on its opposing end faces which are in electrical contact with those stages. The electrode stages 1, 2 and 3 and intervening ceramic rings 5 and 6 together define a vacuum envelope. The thin cylindrical walls adjoining the metallisation on the rings 5 and 6 form vacuum seals and are sufficiently flexible to accommodate any movement during temperature changes so as to maintain integrity of the vacuum seals in these regions

The ring 5 has an axial extent a which is significantly shorter than the distance h in a radial direction between the inner periphery II and the outer periphery 12. The other ring 6 has similar dimensions. The axial extent a is chosen to be great enough to provide sufficient dielectric material to withstand the voltage between collector stages 1 and 2.

As can be seen in FIG. 1A, the metallisation 7 and 9 on the end faces of the ring 5 do not extend across the whole of the surface of those faces. This allows a longer path length from the edge of the metallisation 9 near periphery 11 to the edge of the metallisation 7 near the periphery 11, to give a desired voltage hold-off. As can be seen, the distance between the metallisation 7 and 9 and the outer periphery 12 is larger to achieve the same voltage hold-off because this region is located outside the vacuum envelope.

In this embodiment, the layers of metallisation 7 and 9 together with the thickness a of ceramic material between them together act as a distributed bypass capacitor to prevent leakage of high frequency energy from the interior of the collector and withstand the inter collector voltage whilst minimising the axial extent of the collector.

The second stage 2 comprises a generally cylindrical component 13 and a second component 14 electrically and mechanically connected thereto which has an inclined surface 15 which in use receives the electrons from the beam. The components 13 and 14 together define a passageway 16 through which water flows to provide cooling. A cooling channel 17 is also provided around the first stage 1. The collector is surrounded by an outer can 18 at ground potential and is connected to an ion pump 19 to maintain vacuum.

During use, the stages 1, 2 and 3 are operated at different electrical potentials and any rf energy appearing within the collector is prevented from leaving that region by the distributed by-pass capacitors formed by the ceramic rings 5 and 6 and associated metal plates.

The collector may be used with an IOT, klystron, travelling wave tube or any other device in which it is necessary to collect an electron beam.

FIG. 2 illustrates an alternative aspect of the invention, in which the collector 20 is formed as a single piece. A ceramic annular ring 21 is located between the collector 20 and the main body 22 of the electron beam tube. The construction of the ceramic annular ring 21, and its electrical connection to the two main stages 20, 21 of the electron beam tube are similar to that shown in FIG. 1A.

1. A multi-stage collector for an electron beam tube comprising: at least two electrode stages with a dielectric ring located between them, the ring having a metal plate on each of its end faces electrically connected to respective different stages such that together with the ring they define a high frequency distributed bypass capacitor.

2. A collector as claimed in claim 1 wherein at least one of the metal plates consists of a metallisation layer.

3. A collector as claimed in claim 1 or 2 wherein the ring has an axial length which is shorter than the radial distance between its inner and outer peripheries.

4. A collector as claimed in claim 1, 2 or 3 wherein at least one of the metal plates does not extend to the inner and outer peripheries of the face on which it lies.

5. A collector as claimed in any preceding claim wherein the electrode stages and ring form part of a vacuum envelope.

6. A collector as claimed in a claim 5 wherein the electrode stages contact the metal plates at a location which is closer to the inner periphery than the outer periphery of the ring.

7. A collector as claimed in any preceding claim wherein one of the electrodes stages comprises two components, with one of the components being interposed between the other component and the ring.

8. A collector as claimed in claim 7 wherein a passage exists between the two components to provide a path for coolant fluid.

9. A collector as claimed in any preceding claim wherein the ring is of a ceramic material.

10. An electron beam tube including a collector as claimed in any preceding claim.

11. An electron beam tube comprising two stages, one of which is a collector, with a dielectric ring between them, the ring having a metal plate on each of its end faces electrically connected to the respective stages such, that together with the ring, they define a high frequency distributed bypass capacitor.

12. An electron beam tube as claimed in claim 11, wherein at least one of the metal plates consists of a metallisation layer.

13. An electron beam tube as claimed in claim 11 or 12, wherein the ring has an axial length shorter than the radial distance between its inner and outer peripheries.

14. A high frequency amplifier including an electron beam tube as claimed in any one of claims 10 to 13 and one or more high frequency resonant cavities.

15. A collector substantially as illustrated in and described with reference to the accompanying drawings.

16. An electron beam tube substantially as illustrated in and described with reference to the accompanying drawings.

17. An inductive output tube substantially as illustrated in and described with reference to the accompanying drawings.
